(19) United States
(12) Patent Application Publication
(10) Pub. No.: US 2018/0225796 A1
(43) Pub. Date: Aug. 9, 2018

(54) Resource Allocation in a Network System

(71) Applicant: Uber Technologies, Inc., San Francisco, CA (US)

(72) Inventor: Yifang Liu, Burlingame, CA (US)

(21) Appl. No.: 15/427,440

(22) Filed: Feb. 8, 2017

(51) Int. Cl. G06Q 50/30; G06Q 10/06

(52) U.S. Cl. CPC G06Q 50/30; G06Q 10/06315

(57) ABSTRACT

A network system efficiently allocates providers among different geographic regions by providing multiple service options to users. In one embodiment, the system provides multiple service options responsive to predicting user demand over a threshold volume. The system detects user interest based on the number of user devices that transmit service data indicative of user interest in potentially requesting service. The system selects geographic regions and providers within a threshold distance of the origin location or the geographic region of the origin location for inclusion in a list of service options. The system computes estimated values for each of the selected geographic regions and sends data corresponding to the estimated values to the computing device.

### TECHNICAL FIELD

The subject matter described herein generally relates to the field of network systems, and, more particularly, to optimizing resource allocation among different regions.

### BACKGROUND

Network systems, such as transport management systems, provide support for the logistical issues in managing the transportation of persons, cargo, or the like. In some systems, a provider provides transportation services to a user to a location selected by the user. In typical systems, a user checking a fare or requesting service is matched with one of a plurality of available providers. Typically, the provider with whom the user is matched is the provider who has the shortest estimated time of arrival to the user's pickup location. This may lead to inefficient allocation of resources, particularly in instances where there is high user demand concentrated in a geographic region. For example, vehicles located in geographic regions of low demand may be sitting idle, polluting the air and crowding the street instead of providing service in nearby regions with lower provider supply and higher user demand.

### SUMMARY OF INVENTION

To ensure a more efficient allocation of resources among different geographic regions and a higher rate of user conversion, a network system provides multiple service options to users that may want to request services (e.g., transport or delivery services, also referred to as a trip) through a user application. In one embodiment, the network system provides multiple service options regardless of predicted user demand. In another embodiment, the network system provides multiple service options responsive to predicting that user demand will be greater than a threshold amount or volume. A demand prediction module predicts upcoming demand for services within a specified vicinity or geography and during a time period. In response to predicting that user demand will be greater than a threshold volume at these origin locations, the demand prediction module instructs a geo selection module to request pricing information (e.g., price multiplier data) for geographic regions within a threshold distance of the origin location or the origin geographic region of the user. The geo selection module uses the price multiplier data to select geographic regions for inclusion in a set of service options that can be presented to the user via the user application. In some examples, the geo selection module queries a provider inventory data store for available providers located in the selected geographic regions and selects candidate providers based in part on user input regarding order time (e.g., time when the service is desired).

In one embodiment, for each of the selected geographic regions, the geo selection module selects the provider with the shortest estimated time of pickup (ETP) to the origin location or the shortest estimated time to destination (ETD) to the destination location (e.g., a total time of estimated time of pickup to the origin location from the provider location and estimated time of travel from the origin location to the destination location). Alternatively, for each of the selected geographic regions, the geo selection module determines the ETP for a set of providers in that geographic region (e.g., the shortest ETP or average ETP of the set of providers). In another embodiment, if the geo selection module determines that the ETP to the origin location is the same for multiple providers in the different geographic regions, the geo selection module selects the provider located in the region with the lowest price multiplier. While examples herein describe selections based on ETP for purposes of simplicity, in other examples, the selections can be based on ETD.

After selecting the service options to present to the user, the geo selection module can also query a trip price estimation module to obtain trip estimate values (e.g., estimated prices or costs). The trip price estimation module calculates or computes an estimated value (e.g., estimated trip cost) for each of the selected service options and sends the estimate values to the geo selection module for display on the user client device. The estimated value can be based on an estimated distance to be traveled along a predicted or proposed route(s), and/or estimated duration of time of travel. In some embodiments, the service options and associated estimates are pushed to the user client device if the user subscribes to real-time information push. In other embodiments, the service options and associated estimates are displayed on the user client device responsive to the user checking fares or requesting a service on a user application.

### BRIEF DESCRIPTION OF THE DRAWINGS

FIG. 1 illustrates the system environment for an example network system, in accordance with an embodiment.

FIG. 2 illustrates an interaction diagram for optimizing resource allocation based on demand prediction, in accordance with an embodiment.

FIG. 3 is a conceptual illustration of an example map showing price multipliers and available providers in different geographic regions, in accordance with an embodiment.

FIG. 4 illustrates an example user interface on a user client application for displaying alternative service options.

FIG. 5 illustrates example components of a computer used as part or all of the network system, the user client device, and/or the provider client device, in accordance with an embodiment.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

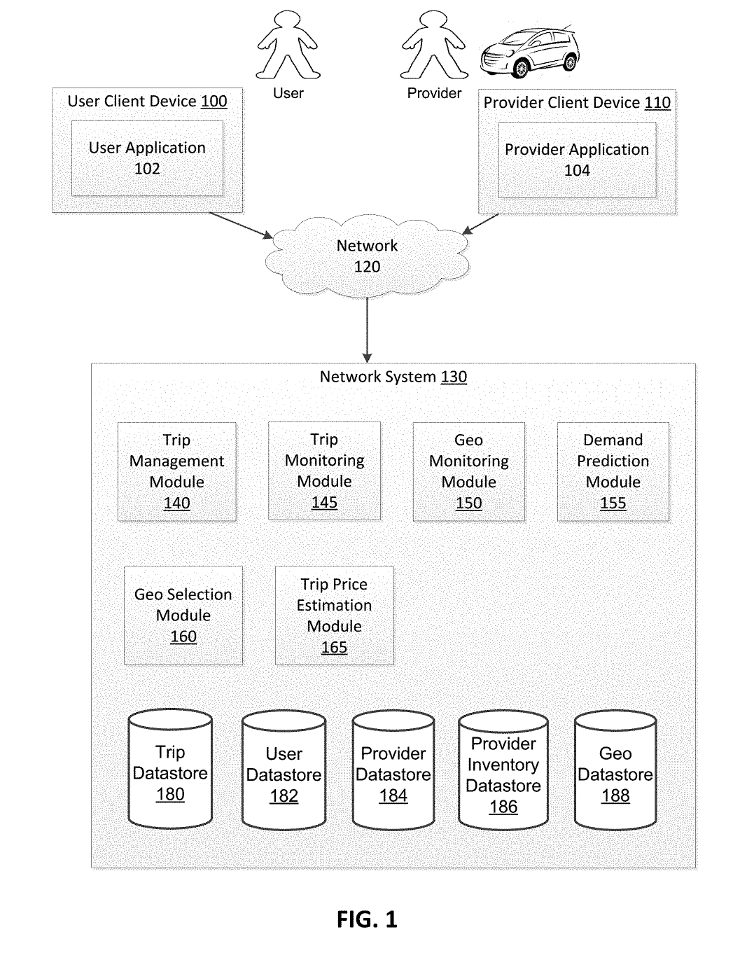

Turning now to the specifics of the system architecture, FIG. 1 illustrates a system environment for an example network system 130. In the example of FIG. 1, the network system 130 coordinates the transportation of persons and/or goods/items for a user (e.g., such as a rider) by a service provider (e.g., a provider of a vehicle). The provider uses a vehicle to provide the transportation to the user. In this example embodiment, the network system 130 includes a trip management module 140, a trip monitoring module 145, a geo monitoring module 150, a demand prediction module 155, a geo selection module 160, a trip price estimation module 165, and various data stores including a trip data store 180, a user data store 182, a provider data store 184, a provider inventory data store 186, and a geo data store 188. These modules and data stores are not native components of a generic computer system, and provide structures and functions beyond generic functions of a computer system, as further described below.

A user operates a client device 100 that executes a user application 102 that communicates with the network system 130. The user operates the user application 102 to view information about the network service 130, and to make a request for service from the network system 130 for a delivery or transport service (“a trip”) of the user (and, optionally, additional persons) and/or items, for example cargo needing transport. The user application 102 determines an origin location or enables the user to specify an origin location and/or a destination location associated with the trip. An origin location and/or a destination location may be a location inputted by the user or may correspond to the current location of the user client device 100 as determined automatically by a location determination module (not shown) in the user client device 100, e.g., a global positioning system (GPS) component, a wireless networking system, or a combination thereof. For purposes of simplicity, as described herein, an origin location can correspond to a start location for service (i) determined by the user application 102 (e.g., based on the current location of the user client device 100 using a GPS component), (ii) specified or selected by the user, or (iii) determined by the network system 130.

According to examples herein, the user client device 100 can transmit a set of data (e.g., referred to herein as “service data”) to the network system 130 over the network(s) 120 in response to user input or operation of the user application 102. Such service data can be indicative of the user's interest in potentially requesting service (e.g., before actually confirming or requesting the service). For example, the user may launch the user application 102 and specify an origin location and/or a destination location to view information about the network service before making a decision on whether to request service. In some examples, the user application 102 provides a feature to enable the user to operate the user application 102 in an option-spectrum feature mode in which the user application 102 presents various service options in response to receiving service data from the user. In other embodiments, the user operates the user application 102 in a default mode in which the user application 102 presents a single trip option in response to receiving the service data.

The user may want to view information about the average or estimated time of arrival for pick up by a provider, the estimated time to the destination, the price, the available service types, etc. Depending on implementation, the service data can include the origin and/or destination location information, user information (e.g., identifier), application information (e.g., version number), device identifier or type, etc. According to some examples, each time the user modifies the origin and/or destination location, the user application 102 can generate and transmit the service data to the network system 130. Still further, in one example, the service data can include data used by the demand prediction module 155 to predict user demand in geographic regions. In some embodiments, the service data comprises a request for an estimated cost or fare for the service and includes at least the origin location and the destination location specified by the user. Additionally, in one example, in response to transmitting the service data, the user application 102 can receive a set of service options from the network system 130 to be displayed on the user client device 100.

Once the user confirms or orders a service via the user application 102, the user application 102 can generate data corresponding to a request for the service through the network system 130 (e.g., also referred to herein as a “trip request”). In some embodiments, the network system 130 uses information from the trip request to match the user with one of a plurality of available providers. Depending on implementation, the trip request can include user or device information (e.g., a user identifier, a device identifier), a service type (e.g., vehicle type) and/or selected service option (such as described herein), an origin location, a destination location, a payment profile identifier, and/or other data. The network system 130 selects a provider from a set of providers, such as based on the provider's current location and status (e.g., offline, online, available, etc.) and/or information from the trip request (e.g., service type, origin location, and/or destination location), to provide the service for the user and transport the user from the origin location to the destination location. In other embodiments, responsive to predicting that user demand will be over a threshold volume in a given geographic region, the network system 130 provides multiple service options to the user, as discussed below. The user client application 102 further enables a user to provide a performance rating for a provider upon completion of a trip. In one embodiment, the rating is provided on a scale of one to five, five being the maximal (best) rating.

The provider operates a client device 110 executing a provider application 104 that communicates with the network system 130 to provide information indicating whether the provider is available or unavailable to provide transportation services to users. The provider application 104 can also present information about the network service to the provider, such as invitations to provide service, navigation instructions, map data, etc. In one embodiment, the provider application 104 enables the provider to provide information regarding availability of the provider by logging into the network system 130 and activating a setting indicating that they are currently available to provide service. The provider application 104 also provides the current location of the provider or the provider client device 110 to the network system 130. Depending on implementation, the current location may be a location inputted by the provider or may correspond to the current location of the provider client device 110 as determined automatically by a location determination module (not shown) in the provider client device 110, e.g., a GPS component, a wireless networking system, or a combination thereof. The provider application 104 further allows a provider to receive, from the trip management module 140, an invitation message to provide a service for a requesting user, and if the provider accepts via input, the provider application 104 can transmit an acceptance message to the trip management module 140. The trip management module 140 can subsequently provide information about the provider to the user application 102. As another embodiment, the provider application 104 can enable the provider to view a list of current trip requests and to select a particular trip request to fulfill. The provider application 104 can also receive routing information from the trip management module 140. The provider application 104 enables a provider to provide a rating for a user upon completion of a trip. In one embodiment, the rating is provided on a scale of one to five, five being the maximal (best) rating.

The user client device 100 and provider client device 110 are portable electronic devices such as smartphones, tablet devices, wearable computing devices (e.g., smartwatches) or similar devices. Alternatively, the provider client device 110 can correspond to an on-board computing system of a vehicle. Client devices typically have one or more processors, memory, touch screen displays, wireless networking system (e.g., IEEE 802.11), cellular telephony support (e.g., LTE/GSM/UMTS/CDMA/HSDPA, etc.), and location determination capabilities.

The user client device 100 and the provider client device 110 interact with the network system 130 through client applications configured to interact with the network system 130. The applications 102 and 104 of the user client device 100 and the provider client device 110, respectively, can present information received from the network system 130 on a user interface, such as a map of the geographic region, and the current location of the user client device 100 or the provider client device 110. The applications 102 and 104 running on the user client device 100 and the provider client device 110 can determine the current location of the device and provide the current location to the network system 130.

The trip management module 140 is configured as a communicative interface between the user application 102, the provider application 104, and the various modules and data stores in the network system 130, and is one means for performing this function. The trip management module 140 is configured to receive provider availability status information and current location information from the provider application 104 and update the provider inventory data store 186 with the availability status. The trip management module 140 is also configured to receive trip requests from the user application 102 and creates corresponding trip records in the trip data store 180. According to an example, a trip record corresponding to a trip request can include or be associated with a trip ID, a user ID, an origin location, a destination location, a service type, pricing information, and/or a status indicating that the corresponding trip request has not been processed. According to one example, when a provider accepts the invitation message to service the trip request for the user, the trip record can be updated with the provider's information as well as the provider's location and the time when the trip request was accepted. Similarly, location and time information about the service as well as the cost for the service can be associated with the trip record.

In one example, the trip management module 140 can also send information to the provider client device 110 at a particular time based on computed estimated travel times. In one embodiment, the trip management module 140 optimizes resource redistribution by computing the time it takes for a provider to initiate the service for a user based on an estimated travel time and/or distance from the provider's current location to the origin location and the requested departure time of the trip. For example, if the estimated travel time to the origin location is ten minutes and the requested departure time is in twenty minutes, the trip management module 140 can select a provider from the geo associated with the selected service option and transmit the invitation message to the selected provider in ten minutes.

In some embodiments, the provider's current location is in a different geographic region (“geo”) than the origin location. The trip management module 140 can transmit provider incentives to the provider application 104 to incentivize the provider to travel from the provider's current location towards a geo nearby or a geo of the origin location. For example, the provider is paid to travel from the provider's current location to the origin location even before the provider is selected to provide a service. The trip management module 140 can display the payment as a standalone incentive or as a component of the provider's income from a specific trip.

In one embodiment, during the trip, the trip monitoring module 145 receives information (e.g., periodically) from the provider application 104 indicating the location of the provider's vehicle and/or telematics information (e.g., indications of current speed, acceleration/deceleration, events, stops, and so forth). The trip monitoring module 145 stores the information in the trip data store 180 and can associate the information with the trip record.

The geo monitoring module 150 determines price multipliers in specified geos as determined by the network system 130, and sends the price multiplier data to the geo data store 188 for storage. Depending on implementation, a geo can be one of many geos that can be user-defined regions, overlapping regions, regions of different sizes or dimensions, and/or regions defined by a coordinate system or array of shapes (e.g., squares, hexagons, etc.). In one example, a geo can be a smaller geo or sub-geo of a larger geo. Each geo can have an identifier, be defined by a set of location data points or coordinates, and/or be associated with additional geos (e.g., with nearby geos or overlapping geos, etc.). For purposes of the description, a “price multiplier” is a scaling modifier based on resource supply and user demand that is applied to an initial or default trip price to determine a final trip price. For example, the geo monitoring module 150 determines a price multiplier for a geo by querying the trip data store 180 for the number of trips requested with an origin location in the geo and by querying the provider inventory data store 186 for the number of available providers located in a geo (e.g., based on location and provider state). As an addition or an alternative, in another example, the geo monitoring module 150 can determine the price multiplier for a geo based on the number of users that are operating the user application 102 but have not yet requested service in the geo. The geo monitoring module 150 can update the price multiplier for a geo periodically (e.g., perform the computation every three minutes or five minutes, etc.) or based on a schedule.

According to an example, the geo monitoring module 150 computes the price multiplier for a geo based, at least in part, on the number of requested trips that originated in the geo, the number of users operating the client application 102 in the geo, and/or the number of available providers located in the geo. In one example, the geo monitoring module 150 can determine a ratio of requested trips and available providers, and if the ratio of requested trips to available providers is over a threshold, the geo monitoring module 150 computes a price multiplier based on the ratio and applies it to the geo. In some embodiments, the geo monitoring module 150 applies progressively higher price multipliers as the ratio of trip requests to available providers increases.

In some examples, the demand prediction module 155 predicts the volume and timing of an upcoming demand peak at or near the vicinity of an origin location. In one embodiment, the demand prediction module 155 predicts volume and timing responsive to the trip management module 140 detecting that user interest or demand will be over a threshold volume. User interest in a geo can be determined by determining the number of users who operate the user application 102 and/or specify service data having an origin location in the geo or set of adjacent or nearby geos during a time period. In another embodiment, the demand prediction module 155 predicts volume and timing based on the number of trip arrivals at the origin location or near the origin location within a specified time period. For example, the demand prediction module 155 can predict user demand at the end of a baseball game based on the arrival volume at the stadium at a time period before the beginning of the game. In other embodiments, the demand prediction module 155 considers both trip arrivals and the number of trip requests when predicting the volume and timing of an upcoming demand peak.

In some embodiments, the demand prediction module 155 generates data regarding the volume and timing of future demand based on future trip requests—that is, requests for trips where the requestor is not seeking to be picked up at the time the request is being made. The demand prediction module 155 generates data regarding trip origins, trip destinations, trip timing, and/or trip length, and uses the data to forecast future demand for trips and the need to provide supply to meet that demand. In some embodiments, the demand prediction module 155 sends the data to the geo monitoring module 150, which uses the data to estimate future prices.

In some embodiments, the demand prediction module 155 considers periodic and non-periodic events when gauging user interest. For example, if the trip management module 140 receives service data from a number of user client devices 100 (e.g., detects a number of users viewing the service information or indicating an intent to request service) and determines that the user client devices 100 are located at or within a baseball stadium or in a geo that the baseball stadium is located in, the trip management module 140 will instruct the demand prediction module 155 to a monitor a feed of the current score and/or estimated time remaining in the game to predict when the demand is likely to be high. The effect of different scores at different times in a game can then be correlated with demand (e.g., demand is low before the end of a tight game because spectators want to stay, but higher if the game is a blow-out with many fans leaving early to beat the rush).

In one embodiment, the demand prediction module 155 employs a machine learning module to improve predictions of demand over time. After any given time period, the estimated demand for that period is compared to the actual demand (i.e., how many trips were actually requested). The difference between the predicted and actual demand can correspond to an error margin that is inputted into the model. If the predicted demand is less than the actual demand, the model is adjusted such that future predictions of demand for similar time periods are larger. Conversely, if the predicted demand exceeded the actual demand, future predictions will be lower. Thus, the model is improved over time to more accurately predict the true demand. The model can also respond dynamically to changes in demand pattern.

In response to predicting that a period of user demand in a geo will be over a threshold volume, the demand prediction module 155 sends an instruction to the geo selection module 160 to query the geo data store 188 for the price multipliers of geos that are within a threshold distance of the origin location or the geo of the origin location (e.g., within a predefined distance, such as one mile or two miles away from the origin location or the geo of the origin location, or within a predefined number of adjacent geos, such as two or three geos away from the origin location or the geo of the origin location). After receiving the requested data about these nearby geos from the geo data store 188, the geo selection module 155 analyzes the data and selects a set of geos for inclusion in the spectrum (or a set or list) of service options that will be presented to the user. In one embodiment, the geo selection module 155 selects all nearby geos. In another embodiment, the geo selection module 155 selects the geo of the origin location and all adjacent geos. In still other embodiments, the geo selection module 155 selects geos with varying price multipliers. For example, the geo selection module 155 might select geos with price multipliers of 1.0×, 2.5×, and 3.0×, respectively.

The geo selection module 160 queries the provider inventory data store 186 for a list of available providers in the selected geos and the location of the providers. In response to receiving the data regarding these candidate providers from the provider inventory data store 186, the geo selection module 160 selects the available rides for inclusion in the spectrum of service options presented on the user client device 100 based on user input regarding order time. For example, if the user is checking service options and costs with an order time of “now,” the geo selection module 160 will select different service options than if the user selected an order time of “20 minutes from now.”

In one embodiment, for each of the selected geos, the geo selection module 160 selects for inclusion the candidate provider with the shortest ETP to the origin location responsive to the user requesting an order time of “now.” For example, assume that the geo selection module 160 selects geo 3 for inclusion in the spectrum of service options presented to a user located in geo 1. If the provider inventory data store reports that, in geo 3, provider A is 15 minutes away from the origin location, provider B is 20 minutes away from the origin location, and provider C is 18 minutes away from the origin location, the geo selection module 160 will select provider A for inclusion as a trip option. In some embodiments, the geo selection module 160 will also include provider B and/or provider C as service options if the geo selection module 160 determines that there is limited provider availability in the other selected geos.

Similarly, in one example, if the geo selection module 160 determines that the ETP to the origin location is similar for providers in different geos, the geo selection module 160 will select for inclusion the candidate provider located in the geo with the lowest price multiplier. For example, assume that provider A (located in geo 2), provider B (located in geo 4), and provider C (located in geo 5) are all 15 minutes away from the user. If geo 5 has the lowest price multiplier of the three geos, the geo selection module 160 will select provider C for inclusion as a trip option.

The geo selection module 160 determines a cut-off point for including candidate providers as service options based on the price multiplier in the provider's geo and the ETP to the origin location. In one embodiment, the geo selection module 160 selects a ceiling or maximum threshold such that when the ETP to the origin location is a specific multiplier of the ETP in the user's geo, the geo selection module 160 stops searching for additional candidate providers to include in the service options presented to the user. In other embodiments, the geo selection module 160 stops searching for additional candidate providers once the estimated trip price begins to increase after reaching its lowest point. After the geo selection module 160 selects the service options to present to the user, the geo selection module 160 queries the trip price estimation module 165 for estimated trip price for each of the selected service options.

The trip price estimation module 165 estimates or determines the cost for a trip based on data from the service data. For example, the cost can be based on the origin location, the destination location, the estimated route to travel, the estimated duration of the service, the service type, the price multiplier, and/or a time when the service is to be provided (e.g., now or in twenty minutes). Depending on implementation, the cost can represent an estimate of the trip price if a user was assigned to a provider at a point in time when the estimate was generated or at some future point in time. A cost may be a single determined price or a range of prices. In some embodiments, the trip price estimation module 165 determines the probability that the actual cost will be less than or equal to the cost estimate, or that the actual cost will fall within a determined price range of the cost estimate. The trip price estimation module 165 can also generate an estimate of the minimum cost for a specified timeframe, and can estimate when that minimum cost may occur.

The trip price estimation module 165 can use models of the cost of a trip to generate a cost estimate within a geo. The models can be based on underlying factors that can impact the cost, such as the duration of the trip, the trip distance, the origin location, the destination, an approximate trip departure time, an estimated time of arrival (“ETA”) at the destination, traffic conditions, the number of passengers on the trip, and/or the type of the provider (e.g., the type of vehicle) servicing the trip. The trip price estimation module 165 may also use historical cost data to generate the cost estimate. For example, the trip price estimation module 165 may use historical traffic condition data to predict traffic during the trip, and how that traffic impacts the cost.

The trip price estimation module 165 may also generate the estimated cost based on the supply of resources and the demand for trips in the geo of the origin location. For example, if many providers are available to provide trips as compared to the number of potential users that may request trips, the estimated cost may be lower. Similarly, if many users are requesting trips as compared to the number of available providers, the estimated cost may be higher. In some embodiments, the trip price estimation module 165 applies a price multiplier during periods of peak user demand.

The trip price estimation module 165 uses a fare calculation scheme to estimate a cost for each of the selected service options. In one embodiment, the total estimated cost comprises a trip cost and a pickup cost. The trip cost can be based on the estimated duration of the trip from the origin location to the destination location and/or the estimated distance traveled of the trip, and the price multiplier in the geo in which the provider is currently located. The pickup cost includes the estimated duration and/or distance of the trip from the provider's current location to the origin location and the price multiplier in the provider's geo. In some embodiments, the pickup cost is zero if the origin location and provider location are within a small or predefined distance or estimated travel time (e.g., 5 minutes) from each other.

After the trip price estimation module 165 calculates the estimated costs for each of the selected service options, the trip price estimation module 165 provides the total estimated costs to the geo selection module 160, which transmit data about the service options with the associated cost estimates to the user client device 100 for displaying via the user application 102. In one embodiment, the service options are automatically pushed to the user client device 100 responsive to the user subscribing to a real-time information push. In other embodiments, the service options are displayed on the user client device 100 responsive to the user specifying the origin location and/or the destination location on the user application 102.

In one embodiment, the geo selection module 160 orders the list of service options from quickest (e.g., the earliest the user can receive service) to slowest. In another embodiment, the geo selection module 160 orders the list from least expensive to most expensive. In still other embodiments, responsive to the demand prediction module 155 predicting that user demand will be over a threshold volume, the geo selection module 160 orders the list of service options sent to the user client device 100 such that providers who are located further away are displayed first. For example, if the demand prediction module 155 determines that the demand at a geo will be over a threshold volume in twenty minutes, the geo selection module 160 will order the list of service options presented to users considering making a trip request from the geo such that providers who are located approximately twenty minutes away are presented first.

The trip data store 180 maintains a record of each in-progress and/or each completed trip coordinated by the network system 130. More specifically, each trip provided by a provider to a user is characterized by a set of attributes (or variables), which together form a trip record that is stored in the trip data store 180. The attributes describe aspects of the provider, the user, and the trip. In one embodiment, each trip record includes or is associated with a trip identifier (ID), a user ID, a provider ID, the origin location, the destination location, the duration of the trip, the service type for the trip, estimated time of pick up, actual time of pickup, and provider rating by user, user rating by provider, fare information, market information, and/or other environmental variables as described below. The variables for the trip record are thus drawn from multiple sources, including the user's master and usage records in the user data store 182, the provider's master and operational records in the provider data store 184, and specific variables captured and received during each trip.

The provider data store 184 stores account and operational information for each provider who participates in the network system 130. For each provider, the provider data store 184 stores one or more database records associated with the provider, including both master data and usage data. In some examples, master data for a provider includes or is associated with the provider's name, provider's license information, insurance information, vehicle information (year, make, model, vehicle ID, license plate), address information, cell phone number, payment information (e.g., credit card number), sign-up date, provider service type (regular, luxury, van, etc.), device type (e.g., type of cell phone), platform type (e.g., iOS, Android), application ID, and/or application version for the provider application 104. The usage data can correspond to historical information about the provider's services received, provided, canceled, and/or completed, such as the times, locations, and routes traveled associated with such services.

The provider inventory data store 186 stores provider availability status information received from the trip management module 140, including whether the provider is available for matching and the location of the provider (which gets updated periodically). When the trip management module 140 receives a trip request, the trip management module 140 determines, from the provider inventory data store 186, which providers are potential candidates to pick up the user for the newly created trip. When the network system 130 marks a trip record as complete, the network system 130 can add the provider back into the inventory of available providers in the provider inventory data store 186.

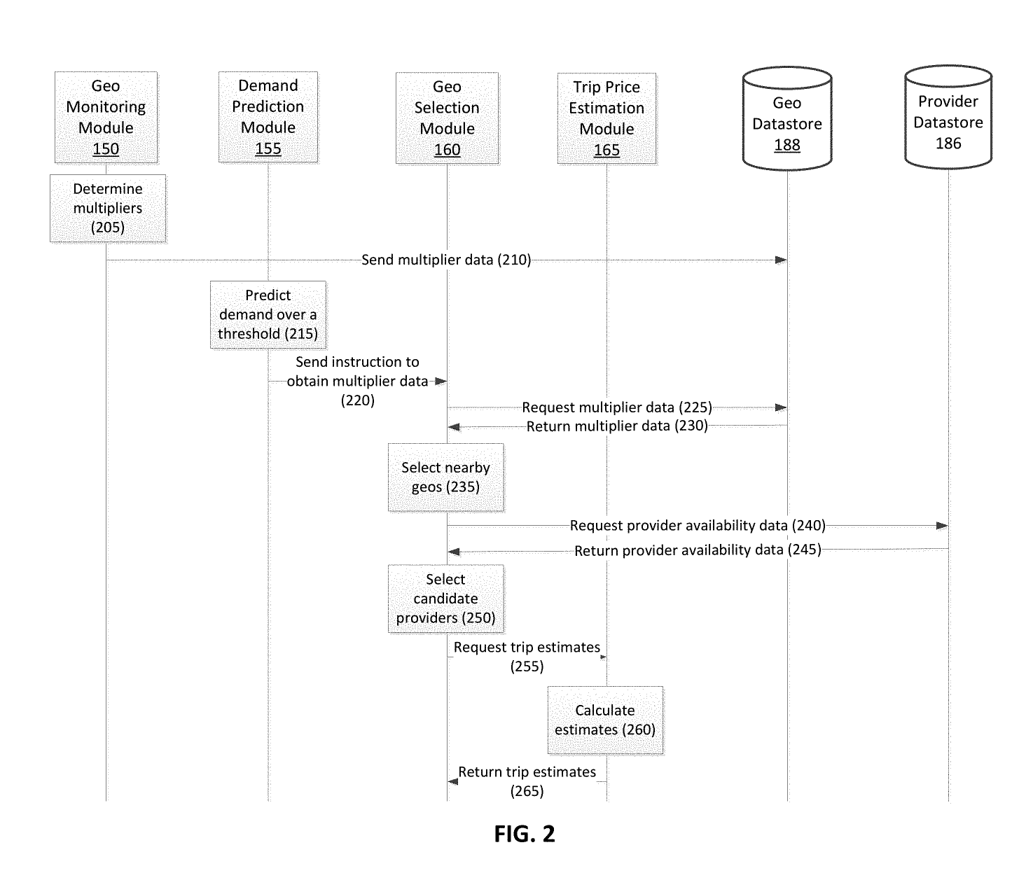

FIG. 2 illustrates an interaction diagram for optimizing resource allocation based on demand prediction, according to an embodiment. At 205, the geo monitoring module 150 determines price multipliers of geos and sends 210 the price multiplier data to the geo data store 188 for storage. In one embodiment, the geo monitoring module 150 determines price multipliers by comparing the ratio of trip requests in a geo with the number of available providers. If the ratio of trip requests to available providers is over a threshold, the geo monitoring module 150 applies a price multiplier to the geo. In some embodiments, the geo monitoring module 150 applies progressively higher price multipliers as the ratio of trip requests to available providers increases.

The demand prediction module 155 predicts the volume and timing of an upcoming demand peak at or near the vicinity of an origin location. If the demand prediction module 155 predicts 215 that user demand will be over a threshold volume in the geo containing the origin location, the demand prediction module 155 sends 220 an instruction to the geo selection module 160 to obtain price multiplier data for geos within a threshold distance of the origin location. In one embodiment, the demand prediction module 155 predicts volume and timing of an upcoming demand peak responsive to the trip management module 140 detecting that user interest will be over a threshold volume based on the number of users who make a trip request through the user application 102 within a specified vicinity or geography and during a time period. In another embodiment, the demand prediction module 155 predicts volume and timing based on the number of trip arrivals at the origin location within a specified time period. In still other embodiments, the demand prediction module 155 considers both trip arrivals and the number of users making trip requests when predicting the volume and timing of an upcoming demand peak.

At 225, the geo selection module 160 queries the geo data store 188 for price multipliers in geos within a threshold distance of the origin location. Responsive to the geo data store 188 returning 230 the requested data regarding these nearby geos, the geo selection module 160 selects 235 geos for inclusion in the list of service options that will be presented to the user. In one embodiment, the geo selection module 160 selects all nearby geos. In another embodiment, the geo selection module 160 selects the geo in which the origin location is located and all adjacent geos. In still other embodiments, the geo selection module 160 selects geos with varying price multipliers.

After selecting the geos to be included in the spectrum of service options presented on the user client device 100, the geo selection module 160 queries 240 the provider inventory data store 186 for a list of available providers in the selected geos and the location of the providers. At 245, the provider inventory data store 186 returns the requested data regarding these candidate providers, and the geo selection module 160 selects 250 the service options. In one embodiment, for each of the selected geos, the geo selection module 160 selects the candidate provider for whom the ETP to the origin location is the least. In another embodiment, if the geo selection module 160 determines that the ETP to the origin location is the same for candidate providers in different geos, the geo selection module 160 selects the candidate provider located in the geo with the lowest price multiplier. In still other embodiments, the geo selection module 160 selects candidate providers based on user input regarding order time. As an addition or an alternative, the geo selection module 160 determines a cut-off point for including candidate providers as service options based on the price multiplier in the candidate provider's geo and the ETP to the origin location, as discussed above with respect to FIG. 1.

After selecting the service options to present to the user, the geo selection module 160 queries 255 the trip price estimation module 165 for cost estimates. At 260, the trip price estimation module 165 calculates an estimated cost for each of the selected service options. In one embodiment, the estimated cost comprises a trip cost and a pickup cost, as discussed above with respect to FIG. 1. After calculating the estimated costs, the trip price estimation module 165 provides 265 the estimates to the geo selection module 160, which transmits the service options with associated cost estimates for display on the user client device 100. The user operating the user client device 100 can view the service options, the associated ETP, and the associated cost estimates, and select an option to make a request for service. When the user selects a service option, the user application 102 can generate and transmit data corresponding to a trip request to the network system 130. The trip request can include a user identifier, the service type, the origin location, the destination location, and/or information about the selected option.

In response to receiving the data corresponding to the trip request, the trip management module 140 creates a trip record in the trip data store 180 and selects a provider to provide the requested service from the list of candidate providers in the selected geos. In one embodiment, the trip management module 140 selects the candidate provider associated with the selected service option who is closest to the origin location. For example, assume that providers A, B, and C are all associated with a selected service option (e.g., a trip originating in geo 3 with an ETP to the origin location in geo 1 of approximately 20 minutes). If provider A has an ETP of 22 minutes, provider B has an ETP of 20 minutes, and provider C has an ETP of 19 minutes, the trip management module 140 will select provider C to provide the service. In other embodiments, the trip management module 140 selects a candidate provider who is traveling towards the origin location. In still other embodiments, when a candidate provider is providing a service to multiple users at the same time, the trip management module 140 selects the candidate provider who is traveling towards the user's destination.

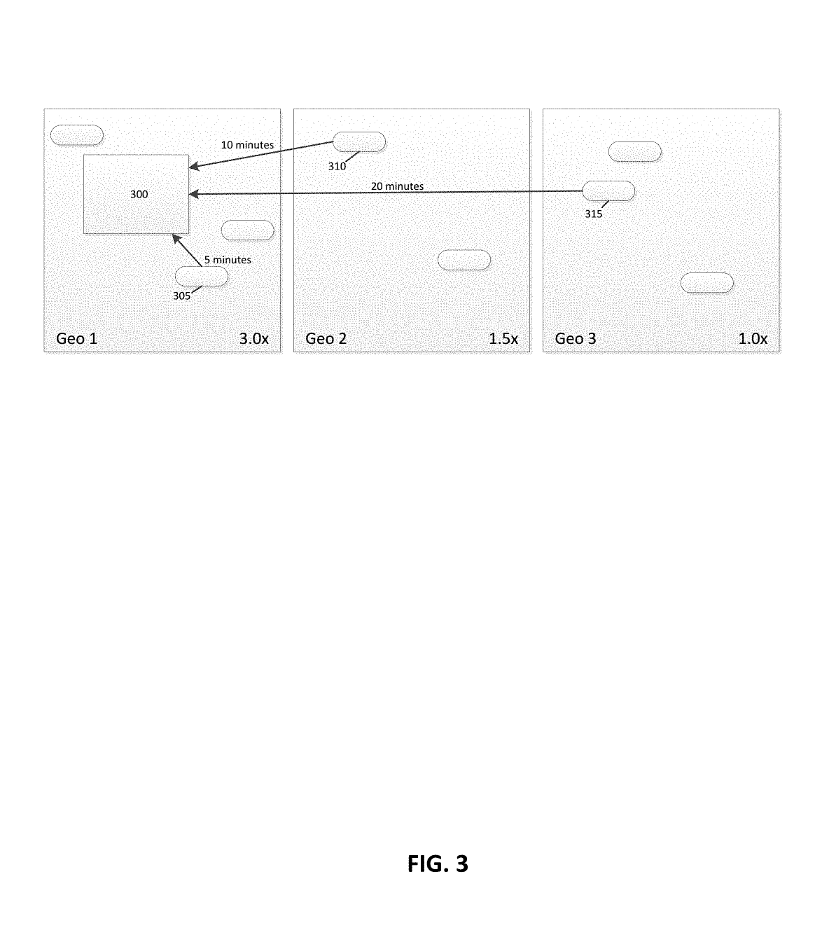

FIG. 3 is a conceptual illustration of an example geo map showing predicted price multipliers and candidate providers in different geos, in accordance with an embodiment. Assume that a user of a user client device 100 is attending a baseball game at a stadium 300 located in geo 1 (or at another event, such as a movie, party, restaurant, etc.). At a current time, e.g., twenty minutes before the end of the game, the user opens the user application 102 to view service information and potentially request a trip. The user can specify or select an origin location, a destination location, and/or a service type and view information about the service, such as the estimated time of arrival to the origin location, the estimated cost or calculated cost for the service, the estimated time to the destination location, etc. For example, in response to the user input, the network system 130 can receive the service data, determine the various service information, and transmit data corresponding to the service information to the user client device 100. In one example, in response to the demand prediction module 155 determining that user demand will be over a threshold volume at a current time or period of time, the geo selection module 160 selects geos and candidate providers to present as one or more service options on the user client device 100. For example, the demand prediction module 155 can determine that user demand is likely to be high in twenty minutes (e.g., near the end of the game at the stadium) as a high number of users at or near that time may operate the user application 102 to view service information and/or to request rides near the stadium to their homes or other locations. Similarly, user demand can be predicted to be high during historically busy time periods (e.g., evening rush hour between 5 and 7 pm). If the demand prediction module 155 predicts that user demand in a geo will be over a threshold volume, the network system 130 selects and presents a spectrum of available service options for users that have specified an origin location in the geo. In one use case example, if the demand prediction module 155 detects high user demand coinciding with the end of a baseball game, the network system presents a spectrum of available service options to both users who are at the game and users who are not at the game (e.g., a user who is requesting a ride home from a restaurant), provided that they are located in the same geo or have specified an origin location in the same geo.

As illustrated in FIG. 3, at an instance in time or period of time, the price multipliers may be different across geos. For example, the demand prediction module 155 predicts that the price multiplier in geo 1, where the user is located at or has specified an origin location at, will be 3.0× near the end of the game at the stadium, while the predicted price multipliers in neighboring geos 2 and 3 are 1.5× and 1.0×, respectively, where x is an initial trip price to which the price multiplier is applied to determine a final cost estimate. The user can be presented with a number of service options with varying price multipliers and ETPs to the origin location. The estimated cost associated with each trip option can be based on the price multiplier in the geo in which the provider(s) is located. For example, for a first service option, a provider 305 has an ETP of five minutes from the origin location (or alternatively, a group of providers in geo 3 have an averaged ETP or shortest ETP of five minutes from the origin location), and the predicted price multiplier in geo 3 is 3.0×. For a second service option, a provider 310 (or group of providers) is determined to have an ETP (e.g., averaged or shortest ETP) of ten minutes from the origin location, and the predicted price multiplier in geo 2 is 1.5×. For a third service option, a provider 315 (or a group of providers) is determined to have an ETP of twenty minutes away from the origin location, and the predicted price multiplier in geo 3 is 1.0×. According to some examples, the predicted price multipliers at a time in the future can be provided to the user client application 102 in conjunction with the service options so that the user may determine the benefit of requesting a service at a later time as compared to a current time.

The network system 130 can provide the service options and the respective costs and ETPs to the user client device 100. In one embodiment, the geo selection module 160 orders the list of available options from quickest to slowest based on ETP. In another embodiment, the geo selection module 160 orders the list from least expensive to most expensive based on the cost estimates of the options calculated by the trip price estimation module 165. For example, if the destination location is a short distance from the origin location, the first trip option might be the least expensive overall (based on the computed cost), despite having the highest price multiplier. In still other embodiments, responsive to the demand prediction module 155 predicting that user demand will be over a threshold volume, the geo selection module 160 orders the list of service options such that providers who are located further away are displayed first. For example, if the demand prediction module 155 predicts high user demand coinciding with the end of a baseball game estimated to end in approximately twenty minutes, the geo selection module 160 will order the list of service options such that third trip option is presented first.

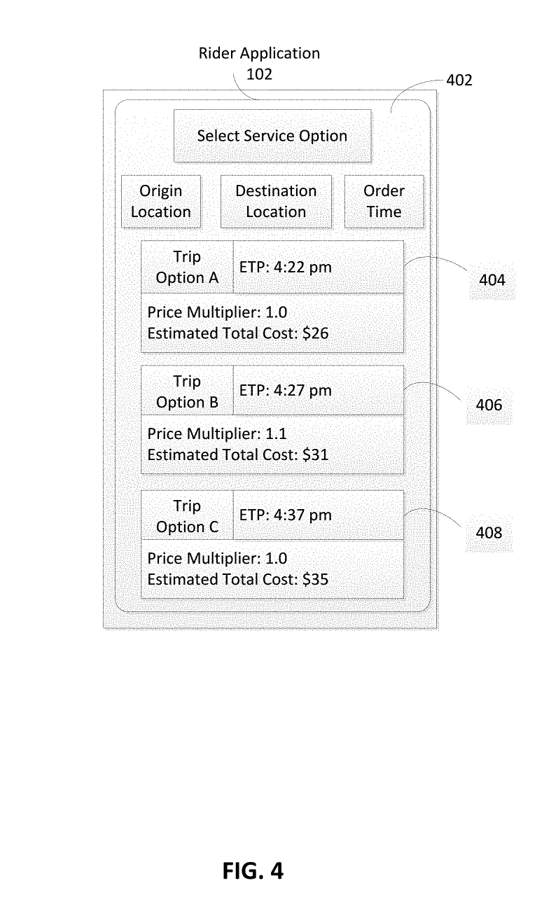

The user client application 102 presents the service options to the user and provides the user with the ability to select a trip option from the presented service options. FIG. 4 illustrates an example user interface 402 on the user client application 102 for displaying alternative service options. In the illustration, the user interface 402 displays the origin location, the destination location, the order time, and the service options 404, 406, and 408. In the illustration, the user interface 402 includes three service options. In other embodiments, more or fewer service options are included. The presentation of each of the service options 404, 406, and 408 includes information about the respective service options, for example, the ETP, the applicable price multiplier, and the estimated cost (or computed guaranteed cost). In some embodiments, the service options include trips with ETPs at the nearby origin location presented in minutes. In other embodiments, the service options include trips with ETPs presented in hours or days.

In embodiments where the order time is hours or days from the time the trip request is made, the demand prediction module 155 uses data from the trip requests to forecast scheduled demand including origin locations, destination locations, and timing. For example, if the number of users requesting rides to the airport in the next week exceeds a threshold, the demand prediction module 155 might infer that the real-time trip requests during the evening commute will be less than usual.

Assume that a user attending a baseball game at a stadium in geo 1 opens the user client application 102 at 4:17 pm, roughly twenty minutes before the end of the game, to make a trip request. The user inputs or specifies the origin location, the destination location, and an order time of “now.” The user can also specify a service option, not illustrated in FIG. 4, for purposes of simplicity. Depending on implementation, in response to receiving the service data or in response to the network system 130 predicting that user demand will be over a threshold volume, the geo selection module 160 can transmit information about the service options 404, 406, 408 to the user client device 100. Trip option A includes one or more providers currently located in the same geo as the user and has an ETP at the origin location of 4:22 pm, 5 minutes from the order time. Because the current demand for rides is low, the price multiplier in geo 1 is 1.0×, and the total estimated cost to the destination location is $26. However, the network system 130 can determine that at a future time, such as in twenty minutes, the predicted price multiplier in geo 1 can be higher than 1.0×, such as 3.0×, due to forecasted demand.

Trip option B includes one or more providers located in neighboring geo 2 arriving at the origin location approximately ten minutes after the order time, at 4:27 pm. The price multiplier in geo 2 is currently 1.1×, and the total estimated cost to the destination location is $31. Though trip option B is more expensive and has a longer ETP than trip option 1, the user might choose trip option B if, for example, the score is close, and the user does not want to leave the game immediately, but may want to leave sometime after 5 minutes. If the user selects trip option B (leave later as opposed to “now”), the network system 130 can select a provider from geo 2 so that the provider can travel from geo 2 to the origin location (e.g., it would take around the ETP time). This can be a better user experience for the user and cheaper than if the user waits eight more minutes before deciding to make a request for “now,” (e.g., making a standard trip request) and if eight minutes later, the estimated price multiplier goes up significantly in geo 1 (e.g., from 1.1× to 1.8×). In such an example, the network system 130 would select a provider closest to the origin location (e.g., select a provider in geo 1 with the price multiplier at 1.8×), but the user would receive the same or similar service at a higher cost than if the user had requested option B for a provider from geo 2 eight minutes before.

Trip option C includes a provider located in geo 3 arriving at the origin location approximately twenty minutes after the order time, at 4:37 μm (i.e., the time the baseball game is estimated to end). The price multiplier in geo 3 is 1.0×, and the total estimated cost to the destination location is $35. In such an example, the total estimated cost for option C would be greater than the total estimated cost for option A (though both have a multiplier of 1.0×) due to the distance and/or duration traveled by the provider from geo 3 to the origin location. Trip option C gives the user an option to remain at the game until its estimated end for a relatively low fare. In such an example, if the user were to select option C (at the current time, 4:17 pm), the network system 130 can select a provider from geo 3, who can start traveling towards the origin location and arrive at the origin location around 4:37 pm. By comparison, if the user waited until the end of the game to make a trip request, the price multipliers may likely increase as more spectators leave the stadium around the same time. In this example, the price multiplier at geo 1 once the game ends can increase (e.g., from 1.0× to 3.0× due to the number of other users in geo 1 that are operating the client applications to potentially request service) so that the estimated cost may be much higher than $26 (e.g., $50), so that if the user were to request service at that time, a provider in geo 1 would be selected at the potentially higher cost. In this manner, the network system 130 can enable resources to be allocated from nearby geographic regions to fulfill demand in a geographic region where demand is higher than normal or forecasted to be higher than normal by providing service options, for services that start at a later time, to users.

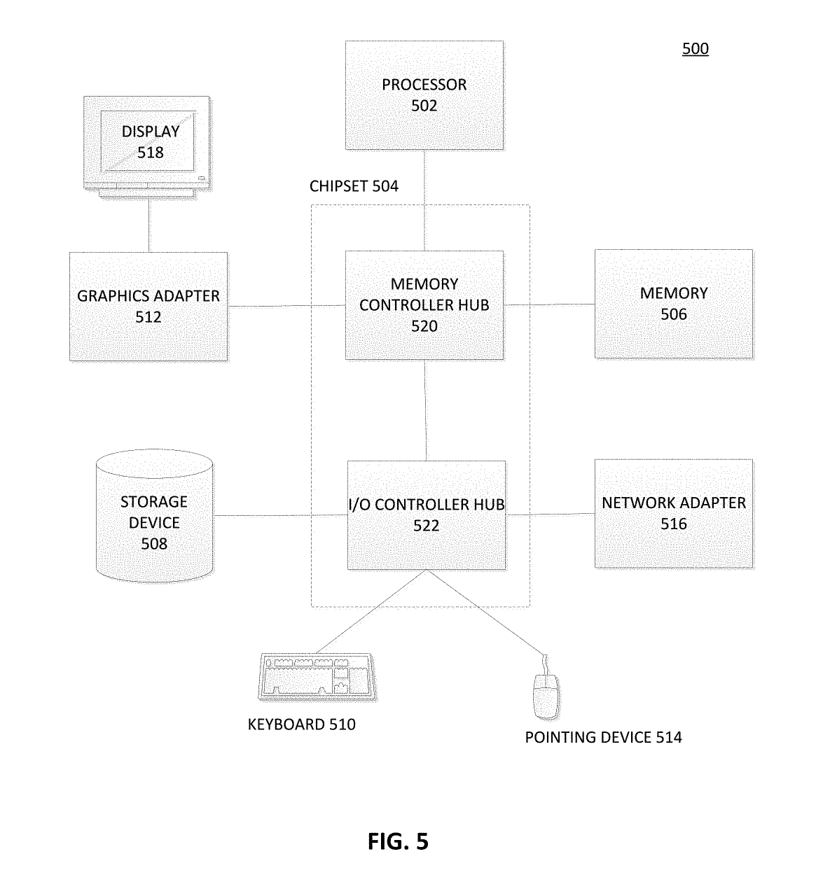

FIG. 5 is a block diagram illustrating physical components of a computer 400 used as part or all of the network system 130, user client device 100, or provider client device 110 from FIG. 1, in accordance with an embodiment. Illustrated are at least one processor 502 coupled to a chipset 504. Also coupled to the chipset 504 are a memory 506, a storage device 508, a graphics adapter 512, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is any non-transitory computer-readable storage medium, such as a hard drive, compact disk read-only memory (CD-ROM), DVD, or a solid-state memory device. The memory 506 holds instructions and data used by the processor 502. The graphics adapter 512 displays images and other information on the display 518. The network adapter 516 couples the computer 500 to a local or wide area network.

As is known in the art, a computer 500 can have different and/or other components than those shown in FIG. 5. In addition, the computer 500 can lack certain illustrated components. In one embodiment, a computer 500, such as a host or smartphone, may lack a graphics adapter 512, and/or display 518, as well as a keyboard 510 or external pointing device 514. Moreover, the storage device 508 can be local and/or remote from the computer 500 (such as embodied within a storage area network (SAN)).

As is known in the art, the computer 500 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 508, loaded into the memory 506, and executed by the processor 502.

The foregoing description described one embodiment of the invention in which the network system 130 presents a spectrum of service options on the user client device 100 responsive to the demand prediction module 155 detecting that user demand will be over a threshold volume. In other embodiments, the trip management system 130 presents a spectrum of service options regardless of the demand forecasted by the demand prediction module 155.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations while described functionally computationally or logically are understood to be implemented by computer programs or equivalent electrical circuits microcode or the like. Furthermore, it has also proven convenient at times to refer to these arrangements of operations as modules without loss of generality. The described operations and their associated modules may be embodied in software firmware hardware or any combinations thereof.

Any of the steps operations or processes described herein may be performed or implemented with one or more hardware or software modules alone or in combination with other devices. In one embodiment a software module is implemented with a computer program product comprising a computer-readable medium containing computer program code which can be executed by a computer processor for performing any or all of the steps operations or processes described.

Embodiments may also relate to an apparatus for performing the operations herein. This apparatus may be specially constructed for the required purposes and/or it may comprise a general-purpose computing device selectively activated or reconfigured by a computer program stored in the computer. Such a computer program may be stored in a non-transitory tangible computer readable storage medium or any type of media suitable for storing electronic instructions which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process where the information is stored on a non-transitory tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description but rather by any claims that issue on an application based hereon. Accordingly, the disclosure of the embodiments of the invention is intended to be illustrative but not limiting of the scope of the invention which is set forth in the following claims.

1. A method for allocating resources for a network system, comprising:
receiving, in a duration of time, sets of service data from a plurality of computing devices, wherein each set of service data comprises an origin location that is in a first geographic region and a destination location; and
responsive to the number of sets of service data received exceeding a threshold number, processing each set of service data by:
selecting a set of geographic regions within a threshold distance of the first geographic region;
determining a set of candidate providers for the first geographic region and for each selected geographic region;
for the first geographic region and for each selected geographic region, computing an estimated value from the origin location to the destination location based at least in part on the respective set of candidate providers' current location in that geographic region; and
transmitting data corresponding to a set of service options to the respective computing device associated with that set of service data, each set of service options being associated with (i) the first geographic region or one of the selected geographic regions, and (ii) the respective estimated value for that geographic region.

2. The method of claim 1, further comprising predicting a period of high user demand responsive to receiving the sets of service data exceeding a threshold number.

3. The method of claim 1, wherein the set of service data comprises a request for an estimated value through the network system.

4. The method of claim 1, wherein selecting a set of geographic regions comprises selecting all geographic regions that are adjacent to the first geographic region.

5. The method of claim 1, wherein selecting a set of geographic regions comprises selecting geographic regions that are each associated with different multipliers.

6. The method of claim 1, wherein determining a set of candidate providers for a geographic region comprises selecting a candidate provider with the shortest estimated time of travel to the origin location.

7. The method of claim 1, wherein the estimated value for a geographic region corresponds to an estimated value associated with travel from the origin location to the destination location and an estimated value associated with travel from a candidate provider's location in that geographic region to the origin location.

8. The method of claim 7, wherein the estimated value associated with travel from the origin location to the destination location is based at least in part on an estimated duration of time from the origin location to the destination location, an estimated distance to be traveled from the origin location to the destination location, and a multiplier.

9. The method of claim 7, wherein the estimated value associated with travel from a candidate provider's location to the origin location is based at least in part on an estimated duration of time from the candidate provider's location to the origin location, an estimated distance to be traveled from the candidate provider's location to the origin location, and a multiplier.

10. A non-transitory computer-readable storage medium storing computer-executable instructions that, in response to executing, cause a device comprising a processor to perform operations, comprising:
receiving, in a duration of time, sets of service data from a plurality of computing devices, wherein each set of service data comprises an origin location that is in a first geographic region and a destination location; and
responsive to the number of sets of service data received exceeding a threshold number, processing each set of data by:
selecting a set of geographic regions within a threshold distance of the first geographic region;
determining a set of candidate providers for the first geographic region and for each selected geographic region;
for the first geographic region and for each selected geographic region, computing an estimated value from the origin location to the destination location based at least in part on the respective set of candidate provider's current location in that geographic region; and
transmitting data corresponding to a set of service options to the respective computing device associated with that set of data, each set of service options being associated with (i) the first geographic region or one of the selected geographic regions, and (ii) the respective estimated value for that geographic region.

11. The non-transitory computer-readable storage medium of claim 10, wherein the operations further comprise predicting a period of high user demand responsive to receiving the sets of service data exceeding a threshold number.

12. The non-transitory computer-readable storage medium of claim 10, wherein the set of service data comprises a request for an estimated value through a network system.

13. The non-transitory computer-readable storage medium of claim 10, wherein selecting a set of geographic regions comprises selecting all geographic regions that are adjacent to the first geographic region.

14. The non-transitory computer-readable storage medium of claim 10, wherein selecting a set of geographic regions comprises selecting geographic regions that are each associated with different multipliers.

15. The non-transitory computer-readable storage medium of claim 10, wherein determining a set of candidate providers for a geographic region comprises selecting a candidate provider with the shortest estimated time of travel to the origin location.

16. The non-transitory computer-readable storage medium of claim 10, wherein the estimated value for a geographic region corresponds to an estimated value associated with travel from the origin location to the destination location and an estimated value associated with travel from a candidate provider's location in that geographic region to the origin location.

17. The non-transitory computer-readable storage medium of claim 16, wherein the estimated value associated with travel from the origin location to the destination location is based at least in part on an estimated duration of time from the origin location to the destination location, an estimated distance to be traveled from the origin location to the destination location, and a multiplier.

18. The non-transitory computer-readable storage medium of claim 16, wherein the estimated value associated with travel from a candidate provider's location to the origin location is based at least in part on an estimated duration of time from the candidate provider's location to the origin location, an estimated distance to be traveled from the candidate provider's location to the origin location, and a multiplier.

19. A computer system comprising:
one or more computer processors for executing computer program instructions; and
a non-transitory computer-readable storage medium storing instructions executable by the one or more computer processors to perform steps comprising:
receiving, in a duration of time, sets of service data from a plurality of computing devices, wherein each set of service data comprises an origin location that is in a first geographic region and a destination location; and
responsive to the number of sets of service data received exceeding a threshold number, processing each set of service data by:
selecting a set of geographic regions within a threshold distance of the first geographic region;
determining a set of candidate providers for the first geographic region and for each selected geographic region;
for the first geographic region and for each selected geographic region, computing an estimated value from the origin location to the destination location based at least in part on the respective set of candidate providers' current location in that geographic region; and
transmitting data corresponding to a set of service options to the respective computing device associated with that set of service data, each set of service options being associated with (i) the first geographic region or one of the selected geographic regions, and (ii) the respective estimated value for that geographic region.

20. The computer system of claim 19, wherein selecting a set of geographic regions comprises selecting geographic regions that are each associated with different multipliers.
